(19) United States
(12) Patent Application Publication
(10) Pub. No.: US 2020/0097789 A1
(43) Pub. Date: Mar. 26, 2020

(54) INDUCTIVE COMFORTER

(71) Applicant: Hop Lion Feather Works Corp., Taipei (TW)

(72) Inventor: Yen Chen Chen, Taipei (TW)

(21) Appl. No.: 16/416,459

(22) Filed: May 20, 2019

(30) Foreign Application Priority Data
Sep. 26, 2018 (TW) 107213050

(51) Int. Cl. G06K 19/077; A47G 9/02

(52) U.S. Cl. CPC G06K 19/07745; A47G 9/0223; G06K 19/07775

(57) ABSTRACT

An inductive comforter has a comforter body and an inductive assembly. The inductive assembly is mounted on the comforter body and includes an inductive chip readable by a sensor. Therefore, as the inductive comforter is free from worn-off bar code or QR code, the inductive comforter will not become unreadable after use over a long time. Moreover, by using a sensor to read an inductive chip, no mechanical or optical contact between the sensor and the inductive chip is needed. Thus, the inductive chip is still readable even if the comforter has been folded and the chip has been covered. Therefore, the personnel's data-reading efficiency will be highly improved.

### BACKGROUND OF THE INVENTION

### 1. Field of the Invention

The present invention relates to a comforter, especially to a customized comforter.

### 2. Description of the Prior Arts

Comforter has been an indispensable daily necessity for human life from the ancient times. As the technology advances, the bedding industry has developed various types of customized comforters on the market nowadays. A customized comforter is designed and made according to specialized data such as the user's sleeping habits, the user's body temperature, and the average temperature of the room.

Because it is necessary for the customized comforter to be sent back to the manufacturer for maintenance for quality control, a comforter structure as describe in Taiwan Patent No. M523391 is provided to help the maintenance process. The comforter structure makes it easier for a personnel of the manufacturer to detach the quilt form the customized comforter in order to improve efficiency.

Though the maintenance efficiency is improved by the comforter structure, the personnel of the manufacturer still has to ask the customer for the specialized data, which is different from user to user, and write it down. This is too complicated for the maintenance process and bothers the customer. Therefore, the manufacturer usually prints a bar code or a QR code (Quick Response Code) on the customized comforter in order to retrieve the specialized data quickly and conveniently when the customized comforter is sent back for maintenance.

However, the bar code or the QR code that is printed on the customized comforter is inevitably prone to wearing off after years of use and therefore may become unreadable eventually. Furthermore, the bar code or the QR code can only be read by directly aligning to a scanner. However, the customer will certainly fold the comforter into a suitable size when carrying the customized comforter back to the manufacturer in a way that the bar code or the QR code may not be directly displayed on the surface of the folded customized comforter. Thus, the personnel of the manufacturer must unfold the comforter and then look for the bar code or the QR code so that they scan the bar code or the QR code. Therefore, the whole procedure wastes a lot of time and labor cost.

To overcome the shortcomings, the present invention provides an inductive comforter to mitigate or obviate the aforementioned problems.

### SUMMARY OF THE INVENTION

The main objective of the present invention is to provide an inductive comforter that will not become unreadable due to wearing off of the bar code or the QR code after years of use. Also, the inductive comforter is able to increase the personnel's efficiency of reading the data regardless of folding.

The inductive comforter has a comforter body and an inductive assembly mounted on the comforter body and comprised an inductive chip which is readable by a sensor.

By mounting an inductive assembly on the comforter body, the present invention uses the inductive chip in the inductive assembly to be read by the sensor. Therefore, the present invention is distinguished from the prior art which will become unreadable after years of use because the bar code or the QR code has worn off. Moreover, using the sensor to read the inductive chip will not have to build a mechanical or optical contact between the sensor and the inductive chip. Thus, the inductive chip is still readable even if the comforter body has been folded and the chip is covered. Therefore, the personnel's data-reading efficiency will be highly improved.

Other objectives, advantages and novel features of the invention will become more apparent from the following detailed description when taken in conjunction with the accompanying drawings.

### BRIEF DESCRIPTION OF THE DRAWINGS

FIG. 1 is a partial enlarged view of an inductive comforter in accordance with the present invention;

FIG. 2 is an exploded view of the inductive comforter in FIG. 1;

FIG. 3 is a perspective view of the inductive comforter in FIG. 1, showing the inductive assembly;

FIG. 4 is an exploded view of the inductive comforter in FIG. 1, showing the inductive assembly;

FIG. 5 is an assembly schematic diagram of the inductive comforter in FIG. 1, showing the wrapping bag and the inductive assembly;

FIG. 6 is a top view of the inductive comforter in FIG. 1, showing the wrapping bag and the inductive assembly; and

FIG. 7 is a perspective view of another embodiment of the inductive comforter in accordance with the present invention.

### DETAILED DESCRIPTION OF THE PREFERRED EMBODIMENTS

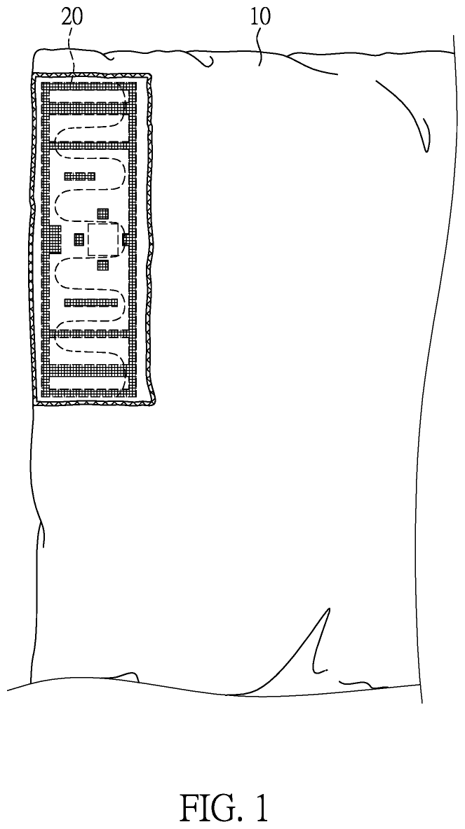

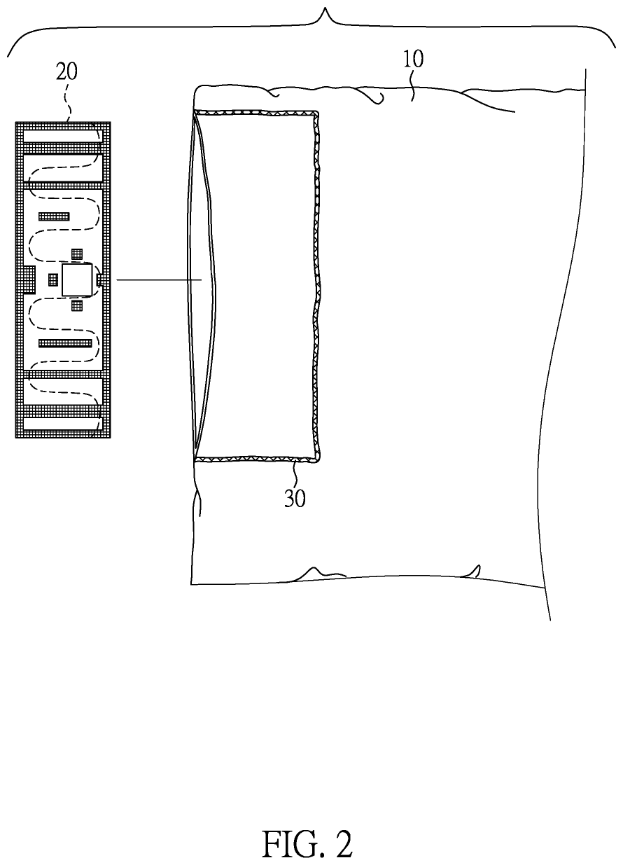

With reference to FIGS. 1 and 2, an inductive comforter in accordance with the present invention comprises a comforter body 10, an inductive assembly 20, and a containing sheet 30.

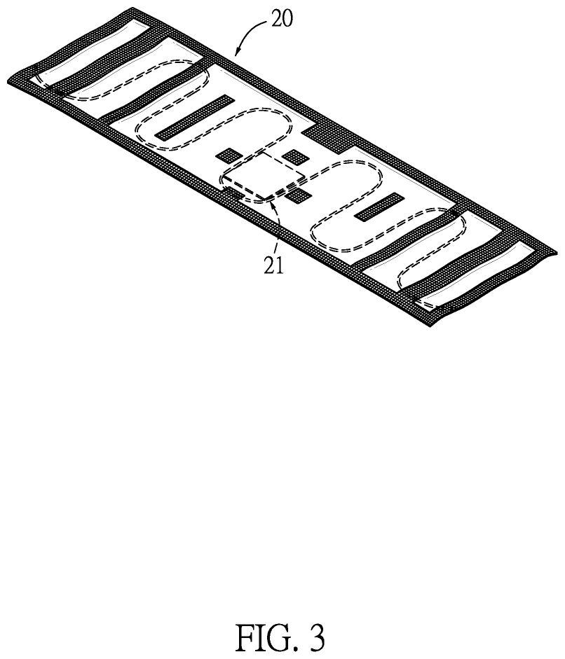

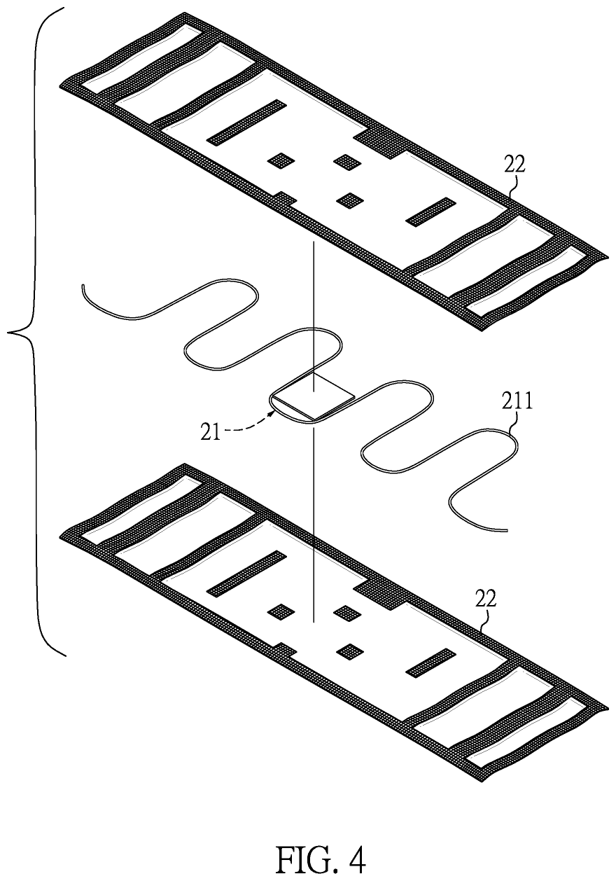

With reference to FIGS. 2 to 4, the inductive assembly 20 is mounted on the comforter body 10 and comprises an inductive chip 21 readable by a sensor. The inductive chip 21 is readable by the sensor, which means that there is no need to build a mechanical or optical contact between the sensor and the inductive chip 21, that is to say, the recognition system is able to read the inductive chip 21 successfully even if the inductive chip 21 is covered. Specifically, in this embodiment, the inductive chip 21 is preferably, but not limited to, a RFID (Radio Frequency Identification) inductive chip. In addition, in this embodiment, the inductive chip 21 is waterproof and comprises an antenna 211 which stretches curvedly, but the inductive chip 21 is not limited to the abovementioned configuration. Alternatively, the inductive chip 21 does not have to comprise an antenna 211, and the inductive chip 21 does not have to be a RFID inductive chip, as long as the inductive chip 21 is readable by the recognition system.

Moreover, the inductive assembly 20 further comprises two covering sheets 22. The two covering sheets 22 clamp the inductive chip 21, and two peripheries of the two covering sheets 22 are mounted securely to each other. Therefore, the inductive chip 21 is protected by the two covering sheets 22. The two covering sheets 22 can reduce the probability of the inductive chip 21 to get damaged during transporting or assembling with the comforter body 10. Also, the two covering sheets 22 are waterproof and resistant to high temperature. Besides, the two covering sheets 22 prevent the comforter body 10 from being scraped by a sharp edge of the inductive chip 21 or by the antenna 211. The inductive assembly 20 is not limited to the abovementioned configuration. The inductive assembly 20 can be implemented without the two covering sheets 22. Thus, the inductive assembly 20 wraps the inductive chip 21 in another way (using a case, for example). The inductive assembly 20 can even be composed only by the inductive chip 21, that is to say, the present invention will still reach the same purpose even if the inductive chip 21 is directly mounted on the comforter body 10.

The inductive assembly 20 can be located in any location on the comforter body 10 and can be combined with the comforter body 10 in any way. In terms of location, the inductive assembly 20 and a wrapping bag 30A can be located inside the comforter body 10, or the inductive assembly 20 and the wrapping bag 30A are mounted on an outer surface of the comforter body 10. Moreover, in this embodiment, the inductive assembly 20 is located on a corner of the comforter body 10 in order to make it easier to manufacture and more convenient to use, but the location is not limited to the abovementioned.

In terms of the combination way, the inductive assembly 20 is mounted on the comforter body 10 through the containing sheet 30 in this embodiment. Specifically, the containing sheet 30 is sewed on the comforter body 10 and the inductive assembly 20 is mounted between the containing sheet 30 and the comforter body 10. More specifically, a periphery of the containing sheet 30 is sewed on the comforter body 10, and an opening is reserved between the comforter body 10 and the periphery of the containing sheet 30 so that the containing sheet 30 and the comforter body 10 form a pocket together and the inductive assembly 20 is mounted in the pocket. Therefore, assembling the inductive assembly 20 and the comforter body 10 will be easy. The opening will be closed after the inductive assembly 20 is mounted in the pocket. After the opening is closed, the inductive assembly 20 will be fixed between the containing sheet 30 and the comforter body 10 so that the inductive assembly 20 is not able to move. The way by which the inductive assembly 20 is mounted on the comforter body 10 is not limited to the abovementioned.

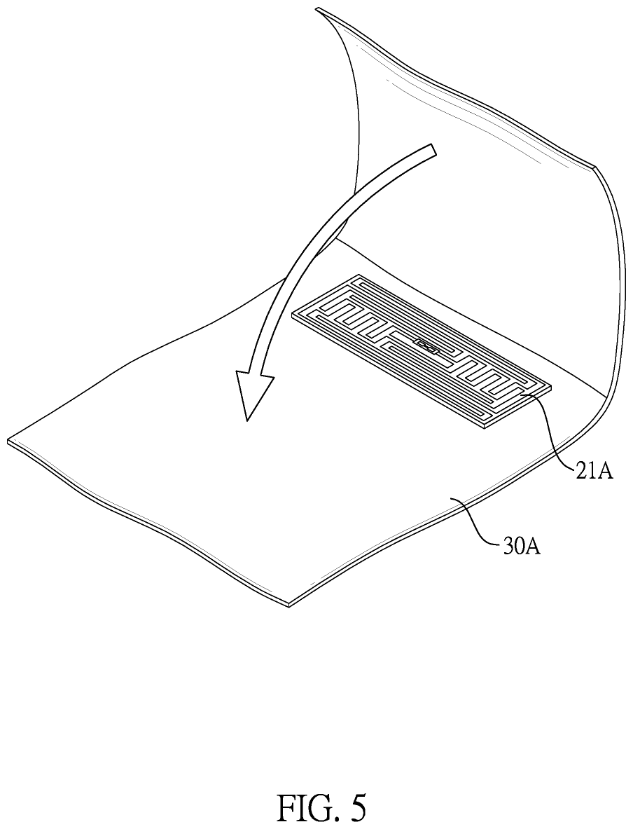

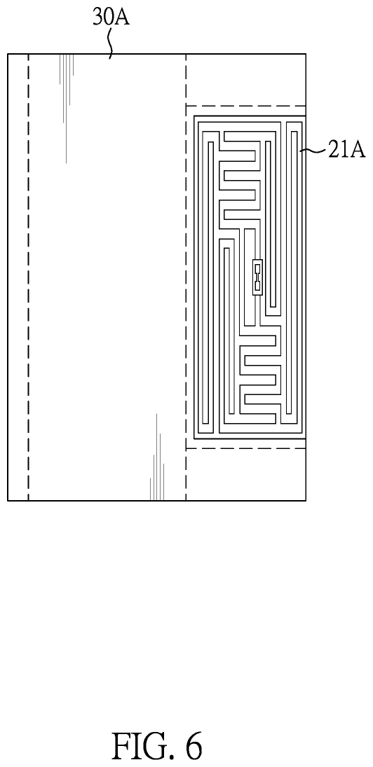

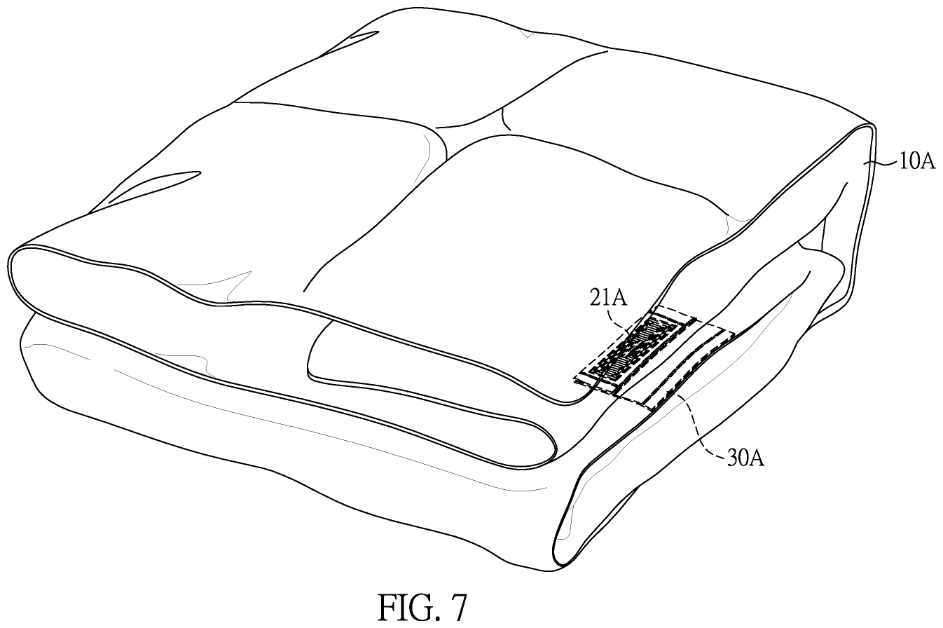

For example, with reference to FIGS. 5 to 7, the present invention further comprises a wrapping bag 30A in another embodiment. In this embodiment, the inductive assembly is only composed of an inductive chip 21A. A side of the wrapping bag 30A is sewed on the comforter body 10A and the inductive chip 21A is mounted in the wrapping bag 30A. Specifically, the wrapping bag 30A is formed by a bending and wrapping sheet that comprises a thread sewed beside a periphery of the inductive chip 21A in order to wrap and fix the inductive chip 21A. This embodiment uses the wrapping bag 30A to wrap the inductive chip 21A in order to prevent the inductive chip 21A from contacting the comforter body 10 directly so that this embodiment does not need a covering sheet or a case to protect the inductive chip 21A. Besides, in this embodiment, the wrapping bag 30A still can flip after the side of the wrapping bag 30A is sewed on the comforter body 10A to facilitate ease in the future's inductive reading, but the way by which the inductive assembly is mounted on the comforter body 10A is not limited to the abovementioned.

For example, the inductive assembly 20 can also be sewed on the comforter body 10. To be specific, regardless that the inductive assembly 20 is sewed on the comforter body 10 directly or via the containing sheet 30 or via the wrapping bag 30A, the inductive assembly 20 can still be located inside the comforter body 10 or sewed on an outer surface of the comforter body 10 or connected to the outer surface of the comforter body 10. Besides, the inductive assembly 20 can be mounted on the comforter body 10 by ways other than the abovementioned way.

By mounting the inductive assembly 20 on the comforter body 10, the present invention uses the inductive chip 21 in the inductive assembly 20 to be read by the sensor. Therefore, the present invention will not become unreadable after years of use because the present invention does not have the problem of the worn-off bar code or QR code. Moreover, using the sensor to read the inductive chip 21 will eliminate the necessity to build a mechanical or optical contact between the sensor and the inductive chip 21. Thus, the inductive chip 21 is still readable even if the comforter body 10 has been folded and the inductive chip 21 is covered. Therefore, the personnel's data-reading efficiency will be highly improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An inductive comforter comprising:
a comforter body; and
an inductive assembly mounted on the comforter body and comprising an inductive chip readable by a sensor.

2. The inductive comforter as claimed in claim 1, wherein the inductive assembly is sewed on the comforter body.

3. The inductive comforter as claimed in claim 1, wherein the inductive comforter further comprises a containing sheet sewed on the comforter body;
and the inductive assembly is mounted between the containing sheet and the comforter body.

4. The inductive comforter as claimed in claim 1, wherein the inductive comforter further comprises a wrapping bag; a side of the wrapping bag is sewed on the comforter body; the inductive chip is mounted in the wrapping bag.

5. The inductive comforter as claimed in claim 4, wherein the wrapping bag is formed by a bending and wrapping sheet; and a thread sewed on the wrapping bag extends along a periphery of the inductive chip.

6. The inductive comforter as claimed in claim 1, wherein the inductive assembly is located inside the comforter body.

7. The inductive comforter as claimed in claim 5, wherein the wrapping bag and the inductive assembly are located inside the comforter body.

8. The inductive comforter as claimed in claim 1, wherein the inductive assembly is mounted on an outer surface of the comforter body.

9. The inductive comforter as claimed in claim 5, wherein the wrapping bag and the inductive assembly are mounted on an outer surface of the comforter body.

10. The inductive comforter as claimed in claim 1, wherein the inductive assembly is located on a corner of the comforter body.

11. The inductive comforter as claimed in claim 5, wherein the wrapping bag and the inductive assembly are located on a corner of the comforter body.

12. The inductive comforter as claimed in claim 1, wherein the inductive assembly further comprises two covering sheets; the two covering sheets clamp the inductive chip; and two peripheries of the two covering sheets are mounted securely to each other.

13. The inductive comforter as claimed in claim 2, wherein the inductive assembly further comprises two covering sheets; the two covering sheets clamp the inductive chip; and two peripheries of the two covering sheets are mounted securely to each other.

14. The inductive comforter as claimed in claim 3, wherein the inductive assembly further comprises two covering sheets; the two covering sheets clamp the inductive chip; and two peripheries of the two covering sheets are mounted securely to each other.

15. The inductive comforter as claimed in claim 12, wherein the inductive chip of the inductive assembly comprises an antenna; the antenna stretches curvedly.

16. The inductive comforter as claimed in claim 13, wherein the inductive chip of the inductive assembly comprises an antenna; the antenna stretches curvedly.

17. The inductive comforter as claimed in claim 1, wherein the inductive chip is waterproof.

18. The inductive comforter as claimed in claim 5, wherein the inductive chip is waterproof.

19. The inductive comforter as claimed in claim 1, wherein the inductive chip is a RFID inductive chip.

20. The inductive comforter as claimed in claim 5, wherein the inductive chip is a RFID inductive chip.
